(19) United States
(12) Patent Application Publication
(10) Pub. No.: US 2019/0069030 A1
(43) Pub. Date: Feb. 28, 2019

(54) DETERMINING EFFECTS OF PRESENTING A CONTENT ITEM TO VARIOUS USERS ON ACTIONS PERFORMED BY THE USERS BASED ON ACTIONS PERFORMED BY USERS TO WHOM THE CONTENT ITEM WAS AND WAS NOT PRESENTED

(71) Applicant: Facebook, Inc., Menlo Park, CA (US)

(72) Inventors: Saul Peretz Jackman, San Mateo, CA (US); William Bullock, Palo Alto, CA (US)

(21) Appl. No.: 15/686,489

(22) Filed: Aug. 25, 2017

(51) Int. Cl. H04N 21/466; G06Q 30/02; G06Q 50/00; G06N 99/00

(52) U.S. Cl. CPC H04N 21/4668; G06N 99/005; G06Q 50/01; G06Q 30/0271

(57) ABSTRACT

An online system determines an effect of presenting a content item in causing users to perform a specific action associated with the content item without excluding presentation of content item from certain users. The online system presents the content item to various users and identifies a set of users not presented with the content item. Based on probabilities of presenting the content item to users of the set and to users to whom the content item was presented, the online system weights users of the set so a distribution of probabilities of being presented with the content item for the set matches a distribution of probabilities of the content item being presented to the users who were presented with the content item. The online system determines a metric based on the weights and occurrences of the specific action by users of the set and users presented with the content item.

### BACKGROUND

This disclosure relates generally to presenting content to users of an online system, and more specifically to the determining an effect of presenting a content item to users on actions performed by the users.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

Publishing users providing content items to an online system for presentation often evaluate effectiveness of presenting a content item via the online system based on differences between actions taken by users to whom the content item was presented during a time interval and actions taken by other users to whom the content item was not presented during the time interval. Conventional methods for evaluating effectiveness of a content item in causing users to whom the content item was presented in perform an action rely on withholding the content item from presentation to certain online system users. However, withholding the content item from presentation to certain online system users increases actions taken by the publishing user when providing the content item to the online system and also reduces the number of online system users to whom the content item may be presented.

### SUMMARY

An online system presents various content items to its users. In various embodiments, the online system receives a content item from a publishing user for presentation to other users of the online system. The received content item is associated with a specific action that the publishing user desires users to perform after being presented with the content item. For example, the content item includes an objective specifying the specific action that the publishing user desires other users to perform when presented with content included in the content item. Example objectives include: installing an application associated with the content item, indicating a preference for the content item, sharing a content item with other users, interacting with an object associated with a content item, purchasing an item via an application associated with the content item, or performing any other suitable action.

As the online system identifies opportunities to present content to users who have characteristics satisfying at least a threshold amount of the targeting criteria included in the content item, the online system includes the content item in one or more selection processes that select content for presentation to users via the identified opportunities. A selection process selects content items for presentation to a user via an identified opportunity based on measures of relevance of the content items to the user, and may account for bid amounts included in various content items when selecting content items for presentation to the user. Hence, the online system presents the content item to a subset of the users of the online system who are eligible to be presented with the content item via identified opportunities where the one or more selection process selected the content item for presentation, while the content item is not presented to users who are eligible to be presented with the content item via identified opportunities where the one or more selection processes do not select the content item for presentation to certain users via identified opportunities.

After presenting the content item to the subset of users eligible to be presented with the content item, the online system identifies a set of users eligible to be presented with the content item who were not presented with the content item. In various embodiment, the online system identifies the set as a percentage of users eligible to be presented with the content item who were not presented with the content item during a specific time interval. As another example, the online system identifies the set as a specific number of users eligible to be presented with the content item who were note presented with the content item during a specific time interval.

Based on characteristics of users of the set who were not presented with the content item and characteristics of users of the subset who were presented with the content item, the online system generates a model that determines probabilities of one or more selection processes selecting the content item for presentation to a user. In various embodiments, the online system selects a percentage of users of the subset and selects the percentage of users of the set. Based on characteristics of the selected percentage of users from the set and from the subset, characteristics of the content item, and content selected for the opportunities to present content identified for the selected percentage of users of the set and of the subset, the online system generates the model, which determines a likelihood of the content item being selected and presented to a user. In various embodiments, the model is any suitable type of machine learned model, which the online system generates using any suitable method. Hence, based on characteristics of a user and characteristics of the content item, the model determines a likelihood of the online system presenting the content item to the user.

By applying the model to characteristics of users of the subset to whom the content item was presented, the online system determines probabilities of the one or more selection processes selecting the content item for presentation to various users of the subset. Similarly, the online system applies the model to characteristics of users of the set to whom the content item was not presented to determine probabilities of the one or more selection processes selecting the content item for presentation to various users of the set. In various embodiments, the online system determines a probability of the one or more selection processes selecting the content item for presentation to each user of the subset. Similarly, the online system determines a probability of the one or more selection processes selecting the content item for presentation to each user of the set in various embodiments.

From the determined probabilities of the content item being selected for presentation to users of the subset and being selected for presentation to users of the set, the online system determines a distribution of probabilities of the one or more selection processes selecting the content item for presentation to users of the subset. Similarly, the online system determines an additional distribution of probabilities of the one or more selection processes selecting the content item for presentation to users of the set based on the determined probabilities. For example, the online system determines a distribution of numbers of users of the subset having different probabilities of the online system selecting the content item and determines an additional distribution of number of users of the set having different probabilities of the online system selecting the content item.

The online system compares the distribution of probabilities of the one or more selection processes selecting the content item for presentation to users of the subset and the distribution of probabilities of the one or more selection processes selecting the content item for presentation to users of the set and generates weights for different ranges of probabilities of the one or more selection processes selecting the content item for presentation. The weights allow the online system to differently weight users of the set having different probabilities of the one or more selection processes selecting the content item, which allows the composition of users of the set to more closely resemble the composition of the subset. In various embodiments, the online system identifies multiples ranges (e.g., 10 ranges, 20 ranges, 50 ranges, 100 ranges) of probabilities of one or more section processes selecting the content item. For a range of probabilities, the online system determines an amount of users of the subset having a determined probability of the one or more selection processes selecting the content item within the range and determines an amount of users of the subset having a determined probability of the one or more selection processes selecting the content item within the range. The online system generates a weight for the range as a ratio of the amount of users of the subset having a determined probability of the one or more selection processes selecting the content item within the range to the amount of users of the subset having a determined probability of the one or more selection processes selecting the content item within the range. In various embodiments, the amount of users of the subset having a determined probability of the one or more selection processes selecting the content item within the range is a percentage of the users of the subset having a determined probability of the one or more selection processes selecting the content item within the range; similarly, the amount of users of the set having a determined probability of the one or more selection processes selecting the content item within the range is a percentage of users of the set having a determined probability of the one or more selection processes selecting the content item within the range. The online system performs the preceding actions for each of the identified ranges to generate a weight for each of the identified ranges.

The online system generates a modified distribution of the probabilities of one or more selection processes selecting the content item for presentation users of the set by applying the weights to users of the set within corresponding ranges of probabilities. For example, the online system generates the modified distribution of the probabilities of the one or more selection processes selecting the content item for presentation to users of the set by multiplying a number of users of the set having a determined probability within a range of probabilities by the weight generated for the range. Applying the weights for ranges of probabilities to users having determined probabilities within the ranges allows the online system to generate a modified distribution of the probabilities of one or more selection processes selecting the content item for presentation to users of the set that is within a threshold amount of the distribution of probabilities of one or more selection processes selecting the content item for presentation to each user of the subset. Hence, if a range of probabilities includes fewer users of the set to whom the content item was not presented than users of the subset to whom the content item was presented, the online system applies a weight for the range that increases the number of users of the set having determined probabilities within the range; similarly, if a range of probabilities includes more users of the set to whom the content item was not presented than users of the subset to whom the content item was presented, the online system applies a weight for the range that decreases the number of users of the set having determined probabilities within the range. This allows the modified distribution of the probabilities of one or more selection processes selecting the content item for presentation to users of the set to be more similar to the distribution of the probabilities of one or more selection processes selecting the content item for presentation to users of the subset. The modified distribution allows the online system to more accurately evaluate an effect of presenting the content item to users in causing the users to perform the specific action by increasing a similarity between the distribution of users of the subset to whom the content item was presented across different probabilities of the one or more selection processes selecting the content item and the modified distribution of users of the set to whom the content item was not presented across different probabilities of the one or more selection processes selecting the content item.

As users of the subset and users of the subset perform various actions, the online system receives information identifying performed actions along with information identifying users who performed the action. In various embodiments, the online system receives information identifying a time when the user performed the action and stores the time in association with the user and the action. From the stored information identifying actions performed by various users, the online system determines a rate of users of the subset performing the specific action after being presented with the content item. In various embodiments, the online system identifies occurrences of the specific action associated with the content item by users of the subset at times after times when the content item was presented to users of the subset who performed the specific action from maintained information associated with users of the subset. The online system determines the rate of users of the subset performing the specific action after being presented with the content item as a ratio of a number of occurrences of the specific action by users of the subset after being presented with the content item to a number of users in the subset.

Similarly, the online system determines an additional rate of users of the set performing the specific action after a time when the content item was presented to the users of the subset based on the stored information identifying actions performed by various users. In various embodiments, the online system identifies occurrences of the specific action associated with the content item by users of the set at times after a time when the content item was presented to one or more users of the subset. When determining the additional rate, the online system accounts for the weights applied to numbers of users of the set having probabilities of the one or more selection processes selecting the content item in different ranges. For a range of probabilities, the online system determines a number of occurrences of the specific action by users of the set to whom the content item was not presented having probabilities of the one or more selection processes selecting the content item within the range and applies the weight for the range to the number of occurrences of the specific action by users of the set. The online system similarly weights numbers of occurrences of the specific action by users of the set having probabilities of the one or more selection processes selecting the content item within other ranges by weights for corresponding ranges. The online system sums the weighted number of occurrences of the specific action by users of the set having probabilities of the one or more selection processes selecting the content item within each range and determines the additional rate as a ratio of the sum of the weighted number of occurrences of the specific action by users of the set having probabilities of the one or more selection processes selecting the content item within each range to the number of users of the set.

Based on a difference between the rate and the additional rate, the online system generates a metric representing an effect of presenting the content item to users on the users performing the specific action. In some embodiments, the metric is the difference between the rate and the additional rate. The online system provides the metric to the publishing user, allowing the publishing user to evaluate an effect of presenting the content item to users on the users performing the specific action associated with the content item.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment of.

FIG. 3 is a flowchart of a method for determining an effect of presenting a content item to users on the users performing a specific action associated with the content item, in accordance with an embodiment.

FIG. 4 is an example comparison of a distribution of probabilities of the one or more selection processes selecting a content item for presentation to users to whom the content item was presented and an additional distribution of probabilities of the one or more selection processes selecting the content item for presentation to users to whom the content item was not presented, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

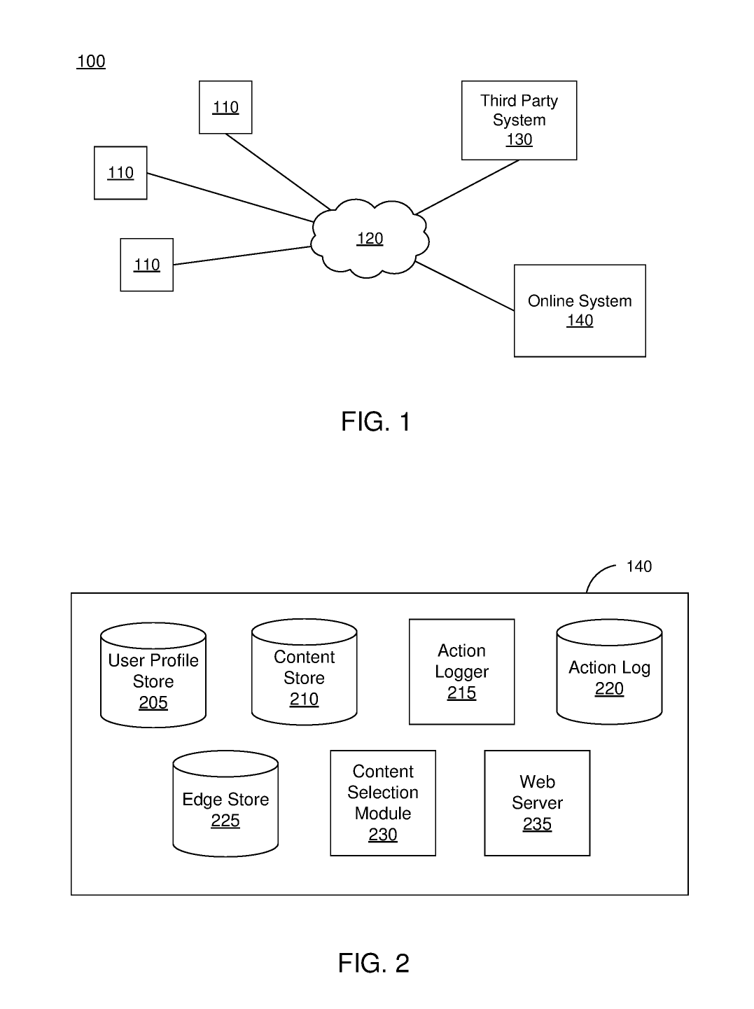

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide inter operability for microwave access (WiMax), 3G, 4G, code division multiple access (COMA), digital subscriber line (DBL.), etc. Examples of networking protocols used for communicating via the network 120 include multi protocol label switching (MILS), transmission control protocol/Internet protocol (TCP/IP), hypertext transport protocol (HTTPS), simple mail transfer protocol (STP), and file transfer protocol (FOP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 130 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, fail over servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographical, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction (or a specific action) that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store 210 for subsequent retrieval by the content selection module 230, which is further described below.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recreation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, Co.-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. Patent application User. No. 12/978,265, filed on Dec. 23, 2010, U.S. Patent application User. No. 13/690,254, filed on Nov. 30, 2012, U.S. Patent application User. No. 13/689,969, filed on Nov. 30, 2012, and U.S. Patent application User. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. Patent application User. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a news feed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

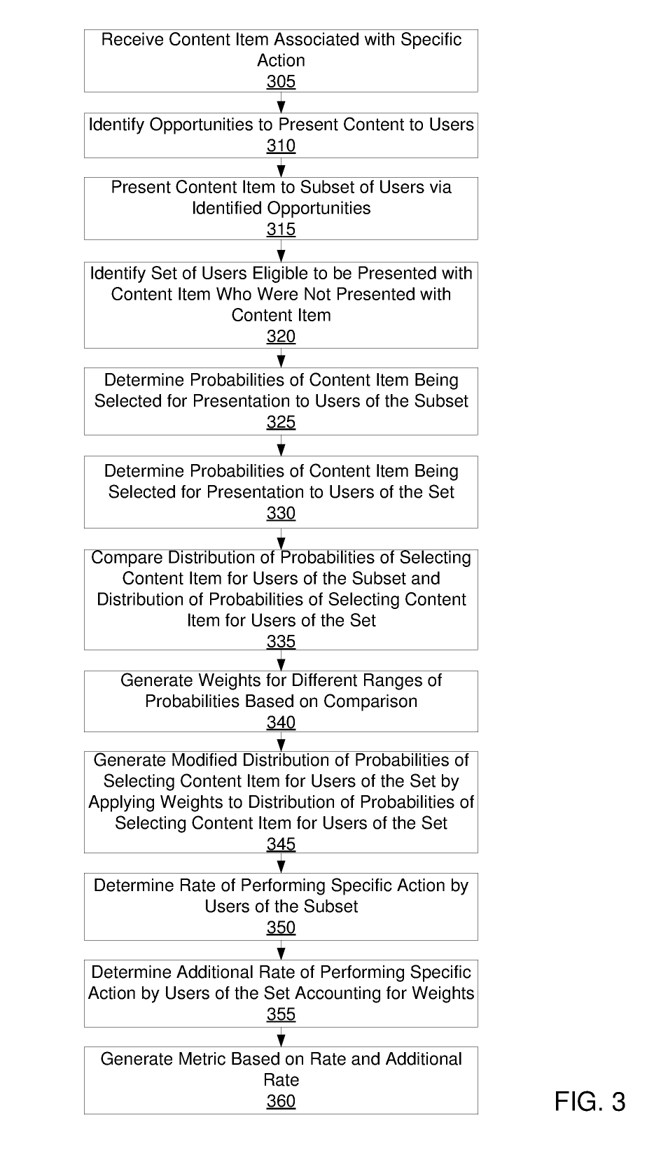

As further described below in conjunction with FIG. 3, the content selection module 230 evaluates an effect of presenting a content item associated with a specific action to various users on likelihoods of users performing the specific action after being presented with the content item. When the content selection module 230 identifies opportunities to present the content item to various users, the content selection module 230 includes the content item in one or more selection processes, as further described above, selecting content items for presentation to a user who is not in the control set via an identified opportunity. Hence, the content item is presented to a subset of the users for whom the one or more selection processes select the content item, while the content item is not presented to other users for whom the one or more content items do not select the content item.

After presenting the content item to the subset of users, the content selection module 230 identifies users to whom the content item was not presented. If the content item includes targeting criteria, the content selection module 230 identifies users having characteristics satisfying at least a threshold amount of the targeting criteria who were not presented with the content item. In various embodiments, the content selection module 230 identifies a set of users to whom the content item was presented during a specific time interval. Based on characteristics of a plurality of the subset of users to whom the content item was presented and of a plurality of the set of users to whom the content item was not presented, the content selection module 230 generates a model that determines a probability of the content item being selected for presentation to a user based on characteristics of the user. The content selection module 230 applies the model to users of the subset to whom the content item was presented to determine probabilities of the one or more selection processes selecting the content item for presentation to various users of the subset. Similarly, the content selection module 230 applies the model to users of the set to whom the content item was not presented to determine probabilities of the one or more selection processes selecting the content item for presentation to various users of the set. As further described below in conjunction with FIG. 3, the content selection module 230 determines a distribution of users of the subset based on their determined probabilities and determines an additional distribution of users of the set base on their determined probabilities. For example, the distribution of users of the subset identifies a number of users of the subset for whom different probabilities, or ranges of probabilities, are determined, while the additional distribution of users of the set identifies a number of users of the set whom different probabilities, or ranges of probabilities, are determined. As further described below in conjunction with FIG. 3, the content selection module 230 compares the distribution and the additional distribution and determines weights for different ranges of probabilities based on the comparison. If the distribution includes a greater number of users in a range than the additional distribution, the content selection module 230 determines a weight for the range that increases a number of users of the additional distribution in the range. Similarly, if the distribution includes fewer users in a range than the additional distribution, the content selection module 230 determines a weight for the range that decreases a number of users of the additional distribution in the range. Hence, applying the determined weights to different ranges of probabilities of the one or more selection processes selecting the content item allows the content selection module 230 to modify the additional distribution to more closely resemble the distribution. As further described below in conjunction with FIG. 3, the content selection module 230 determines a rate at which users of the set to whom the content item was presented performed the specific action after presentation of the content item and determines an additional rate, accounting for the weights applied to different ranges of the determined probabilities, at which users of the set to whom the content item was not presented performed the specific action. Based on a comparison of the rate and the additional rate, the content selection module 230 generates a metric describing an effectiveness of presenting the content item in causing users to perform the specific action.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or Blackberry.

### Determining Effects of Presenting a Content Item to Users Performing an Action

FIG. 3 is a flowchart of one embodiment of a method for determining an effect of presenting a content item to users on the users performing a specific action associated with the content item. In other embodiments, the method may include different and/or additional steps than those shown in FIG. 3. Additionally, steps of the method may be performed in different orders than the order described in conjunction with FIG. 3 in various embodiments.

The online system 140 receives 305 a content item from a publishing user for presentation to other users of the online system 140. The received content item is associated with a specific action that the publishing user desires users to perform after being presented with the content item. As further described above in conjunction with FIG. 2, the content item includes an objective specifying the specific action that the publishing user desires other users to perform when presented with content included in the content item. Example objectives include: installing an application associated with the content item, indicating a preference for the content item, sharing a content item with other users, interacting with an object associated with a content item, purchasing an item via an application associated with the content item, or performing any other suitable action. Additionally, the content item may be associated with a bid amount specifying an amount of compensation the online system 140 receives from the publishing user in exchange for other online system users performing the specific action associated with the content item, as further described above in conjunction with FIG. 2, in various embodiments. The content item also includes targeting criteria specifying characteristics of users of the online system 140 who are eligible to be presented with the content item in various embodiments. If the content item includes targeting criteria, the content item is eligible for presentation to users having characteristics satisfying at least a threshold amount of the targeting criteria and is not eligible for presentation to users having characteristics that do not satisfy at least the threshold amount of the targeting criteria.

As the online system 140 identifies 310 opportunities to present content to users who have characteristics satisfying at least a threshold amount of the targeting criteria included in the content item, the online system 140 includes the content item in one or more selection processes that select content for presentation to users via the identified opportunities. As further described above in conjunction with FIG. 2, a selection process selects content items for presentation to a user via an identified opportunity based on measures of relevance of the content items to the user, and may account for bid amounts included in various content items when selecting content items for presentation to the user. Hence, the online system 140 presents 315 the content item to a subset of the users of the online system 140 who are eligible to be presented with the content item via identified opportunities where the one or more selection process selected the content item for presentation, while the content item is not presented to users who are eligible to be presented with the content item via identified opportunities where the one or more selection processes do not select the content item for presentation to certain users via identified opportunities.

After presenting 315 the content item to the subset of users eligible to be presented with the content item, the online system 140 identifies 320 a set of users eligible to be presented with the content item who were not presented with the content item. In various embodiment, the online system 140 identifies 320 the set as a percentage of users eligible to be presented with the content item who were not presented with the content item during a specific time interval. As another example, the online system 140 identifies 320 the set as a specific number of users eligible to be presented with the content item who were note presented with the content item during a specific time interval.

Based on characteristics of users of the set who were not presented with the content item and characteristics of users of the subset who were presented with the content item, the online system 140 generates a model that determines probabilities of one or more selection processes selecting the content item for presentation to a user. In various embodiments, the online system 140 selects a percentage of users of the subset and selects the percentage of users of the set. Based on characteristics of the selected percentage of users from the set and from the subset, characteristics of the content item, and content selected for the opportunities to present content identified 310 for the selected percentage of users of the set and of the subset, the online system 140 generates the model, which determines a likelihood of the content item being selected and presented 315 to a user. In various embodiments, the model is any suitable type of machine learned model, which the online system 140 generates using any suitable method. Hence, based on characteristics of a user and characteristics of the content item, the model determines a likelihood of the online system 140 presenting 320 the content item to the user.

By applying the model to characteristics of users of the subset to whom the content item was presented, the online system 140 determines 325 probabilities of the one or more selection processes selecting the content item for presentation to various users of the subset. Similarly, the online system 140 applies the model to characteristics of users of the set to whom the content item was not presented to determine 330 probabilities of the one or more selection processes selecting the content item for presentation to various users of the set. In various embodiments, the online system 140 determines 325 a probability of the one or more selection processes selecting the content item for presentation to each user of the subset. Similarly, the online system 140 determines 330 a probability of the one or more selection processes selecting the content item for presentation to each user of the set in various embodiments.

From the determined probabilities of the content item being selected for presentation to users of the subset and being selected for presentation to users of the set, the online system 140 determines a distribution of probabilities of the one or more selection processes selecting the content item for presentation to users of the subset. Similarly, the online system 140 determines an additional distribution of probabilities of the one or more selection processes selecting the content item for presentation to users of the set based on the determined probabilities. For example, the online system 140 determines a distribution of numbers of users of the subset having different probabilities of the online system 140 selecting the content item and determines an additional distribution of number of users of the set having different probabilities of the online system 140 selecting the content item.

The online system 140 compares 335 the distribution of probabilities of the one or more selection processes selecting the content item for presentation to users of the subset and the distribution of probabilities of the one or more selection processes selecting the content item for presentation to users of the set. Based on the comparison, the online system 140 generates 340 weights for different ranges of probabilities of the one or more selection processes selecting the content item for presentation. The weights allow the online system 140 to differently weight users of the set having different probabilities of the one or more selection processes selecting the content item, which allows the composition of users of the set to more closely resemble the composition of the subset.

In various embodiments, the online system 140 identifies multiples ranges (e.g., 10 ranges, 20 ranges, 50 ranges, 100 ranges) of probabilities of one or more section processes selecting the content item. The online system 140 may use any suitable criteria to identify the different ranges in various embodiments. For a range of probabilities, the online system 140 determines an amount of users of the subset having a determined probability of the one or more selection processes selecting the content item within the range and determines an amount of users of the subset having a determined probability of the one or more selection processes selecting the content item within the range. The online system 140 generates 340 a weight for the range as a ratio of the amount of users of the subset having a determined probability of the one or more selection processes selecting the content item within the range to the amount of users of the subset having a determined probability of the one or more selection processes selecting the content item within the range. In various embodiments, the amount of users of the subset having a determined probability of the one or more selection processes selecting the content item within the range is a percentage of the users of the subset having a determined probability of the one or more selection processes selecting the content item within the range; similarly, the amount of users of the set having a determined probability of the one or more selection processes selecting the content item within the range is a percentage of users of the set having a determined probability of the one or more selection processes selecting the content item within the range. Hence, the weight for the range is a ratio of the percentage of the users of the subset having a determined probability of the one or more selection processes selecting the content item within the range to a percentage of the users of the set having a determined probability of the one or more selection processes selecting the content item in various embodiments. The online system 140 performs the preceding actions for each of the identified ranges to generate 340 a weight for each of the identified ranges.

The online system 140 generates 345 a modified distribution of the probabilities of one or more selection processes selecting the content item for presentation users of the set by applying the weights to users of the set within corresponding ranges of probabilities. For example, the online system 140 generates 345 the modified distribution of the probabilities of the one or more selection processes selecting the content item for presentation to users of the set by multiplying a number of users of the set having a determined probability within a range of probabilities by the weight generated 340 for the range. Applying the weights for ranges of probabilities to users having determined probabilities within the ranges allows the online system 140 to generate 345 a modified distribution of the probabilities of one or more selection processes selecting the content item for presentation to users of the set that is within a threshold amount of the distribution of probabilities of one or more selection processes selecting the content item for presentation to each user of the subset. Hence, if a range of probabilities includes fewer users of the set to whom the content item was not presented than users of the subset to whom the content item was presented, the online system 140 applies a weight for the range that increases the number of users of the set having determined probabilities within the range; similarly, if a range of probabilities includes more users of the set to whom the content item was not presented than users of the subset to whom the content item was presented, the online system 140 applies a weight for the range that decreases the number of users of the set having determined probabilities within the range. This allows the modified distribution of the probabilities of one or more selection processes selecting the content item for presentation to users of the set to be more similar to the distribution of the probabilities of one or more selection processes selecting the content item for presentation to users of the subset. The modified distribution allows the online system 140 to more accurately evaluate an effect of presenting the content item to users in causing the users to perform the specific action by increasing a similarity between the distribution of users of the subset to whom the content item was presented across different probabilities of the one or more selection processes selecting the content item and the modified distribution of users of the set to whom the content item was not presented across different probabilities of the one or more selection processes selecting the content item.

As users of the subset and users of the subset perform various actions, the online system 140 receives information identifying performed actions along with information identifying users who performed the action. The online system 140 stores a description of an action performed by a user in association with information identifying the user, such as a user identifier, as further described above in conjunction with FIG. 2. In various embodiments, the online system 140 receives information identifying a time when the user performed the action and stores the time in association with the user and the action. This allows the online system 140 to maintain a log of actions performed by users as well as times when the users performed the actions.

From the stored information identifying actions performed by various users, the online system determines 350 a rate of users of the subset performing the specific action after being presented with the content item. In various embodiments, the online system 140 identifies occurrences of the specific action associated with the content item by users of the subset at times after times when the content item was presented to users of the subset who performed the specific action from maintained information associated with users of the subset. The online system 140 determines 350 the rate of users of the subset performing the specific action after being presented with the content item as a ratio of a number of occurrences of the specific action by users of the subset after being presented with the content item to a number of users in the sub set.

Similarly, the online system determines 355 an additional rate of users of the set performing the specific action after a time when the content item was presented to the users of the subset based on the stored information identifying actions performed by various users. In various embodiments, the online system 140 identifies occurrences of the specific action associated with the content item by users of the set at times after a time when the content item was presented to one or more users of the subset. When determining 355 the additional rate, the online system 140 accounts for the weights applied to numbers of users of the set having probabilities of the one or more selection processes selecting the content item in different ranges. For a range of probabilities, the online system 140 determines a number of occurrences of the specific action by users of the set to whom the content item was not presented having probabilities of the one or more selection processes selecting the content item within the range and applies the weight for the range to the number of occurrences of the specific action by users of the set. The online system 140 similarly weights numbers of occurrences of the specific action by users of the set having probabilities of the one or more selection processes selecting the content item within other ranges by weights for corresponding ranges. The online system 140 sums the weighted number of occurrences of the specific action by users of the set having probabilities of the one or more selection processes selecting the content item within each range and determines 355 the additional rate as a ratio of the sum of the weighted number of occurrences of the specific action by users of the set having probabilities of the one or more selection processes selecting the content item within each range to the number of users of the set.

Based on a difference between the rate and the additional rate, the online system 140 generates 360 a metric representing an effect of presenting the content item to users on the users performing the specific action. In some embodiments, the metric is the difference between the rate and the additional rate. Alternatively, the metric is a ratio of a difference between the rate and the additional rate to the additional rate. In other embodiments, the metric has a value in response to the rate exceeding the additional rate and an alternative value in response to the additional rate exceeding the rate. The online system 140 provides the metric to the publishing user, allowing the publishing user to evaluate an effect of presenting the content item to users on the users performing the specific action associated with the content item.

In some embodiments, the online system 140 generates an additional model determining a likelihood of a user performing the specific action if not presented with the content item based on characteristics of users of the set to whom the content item was not presented. The online system 140 may generate the additional model based on characteristics of users of the set who performed the specific action using any suitable machine learning method. Alternatively, the online system 140 generates the additional model by identifying occurrences of the specific action by online system users prior to presentation of the content item to users of the subset; based on characteristics of users who performed the specific action without being presented with the content item, the online system 140 generates the additional model using any suitable method. The online system 140 may subsequently apply the additional model to characteristics of users of the set or to users of the subset to determine the likelihood of various users performing the specific action without being presented with the content item. In some embodiments, the online system 140 determines an average likelihood of users of the subset performing the specific action without being presented with the content item or an average likelihood of users of the set performing the specific action without being presented with the content item based on application of the additional model to users of the subset or to users of the set, respectively. The online system 140 may provide the publishing user with information describing the average likelihood of users of the set or of the subset performing the specific action without being presented with the content item to allow the publishing user to further evaluate an effectiveness of presenting the content item in causing users to perform the specific action.

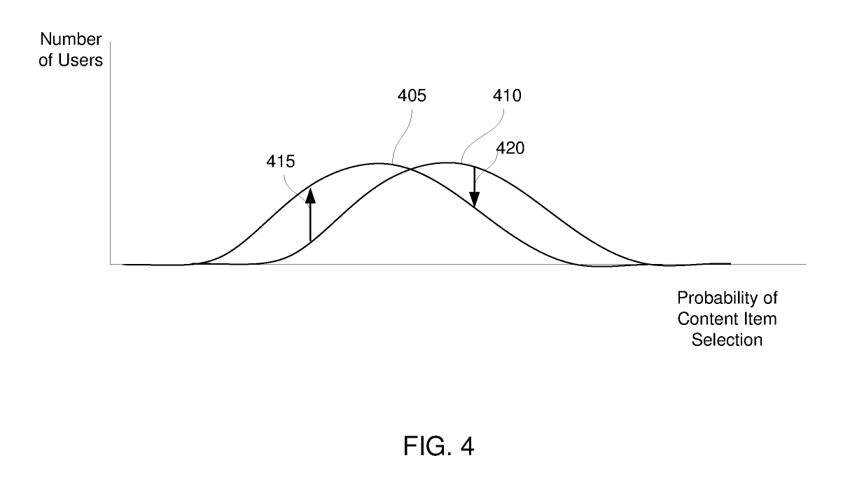

FIG. 4 is an example comparison of a distribution 405 of probabilities of the one or more selection processes selecting a content item for presentation to users to whom the content item was presented and an additional distribution 410 of probabilities of the one or more selection processes selecting the content item for presentation to users to whom the content item was not presented. In the example of FIG. 4, the distribution 405 identifies a number of users to whom the content item was presented against different probabilities of the content item being selected for presentation to the users to whom the content item was presented. Similarly, the additional distribution 410 identifies a number of users to whom the content item was not presented against different probabilities of the content item being selected for presentation to the users to whom the content item was not presented.

As shown in FIG. 4, the distribution 405 and the additional distribution 410 have different characteristics, to mitigate the differences between the distribution and the additional distribution 410, the online system 140 generates weights applied to the additional distribution 410 that mitigate differences between the distribution 405 and the additional distribution 410, as further described above in conjunction with FIG. 3. The online system 140 determines weights for different ranges of probabilities of the content item being selected that modify a number of users to whom the content item was not presented having probabilities within different ranges. In the example of FIG. 4, the online system determines a weight 415 that increases a number of users to whom the content item was not presented within a range of probabilities because the online system 140 determines the distribution 405 includes a greater number of users to whom the content item was presented within the range than a number of users to whom the content item was not presented included in the additional distribution 410 within the range. Similarly, the online system determines an additional weight 420 that decreases a number of users to whom the content item was not presented within an additional range of probabilities because the online system 140 determines the distribution 405 includes a fewer number of users to whom the content item was presented within the additional range than a number of users to whom the content item was not presented included in the additional distribution 410 within the additional range. Hence, the online system 140 applies the weight 415 to a number of users to whom the content item was not presented within the range of probabilities and applies the additional weight 420 to a number of users to whom the content item was not presented within the additional range of probabilities. This allows the online system 140 to modify the additional distribution 410 so its distribution of users to whom the content item was not presented across different probabilities matches, or has at least a threshold similarity to, a distribution of users to whom the content item was presented across different probabilities, which allows the online system 140 to more accurately evaluate effectiveness of the content item in causing user action based on actions performed by users to whom the content item was presented and actions performed by users to whom the content item was not presented.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, micro code, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigure by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a content item at an online system from a publishing user for presentation to users of the online system, the content item associated with a specific action and including targeting criteria identifying characteristics of users of the online system eligible to be presented with the content item;
identifying opportunities to present content to users of the online system having characteristics satisfying at least a threshold amount of the targeting criteria included in the content item;
presenting the content item to a subset of the users of the online system having characteristics satisfying at least a threshold amount of the targeting criteria included in the content item;
identifying a set of users of the online system to whom the content item was not presented and having criteria satisfying the targeting criteria included in the content item;
determining probabilities of one or more selection processes selecting the content item for presentation to various users of the subset to whom the content item was presented by applying a model to characteristics of each user of the sub set;
determining probabilities of one or more selection processes selecting the content item for presentation to various users of the set to whom the content item was not presented by applying the model to characteristics of each user of the sub set;
comparing a distribution of the probabilities of one or more selection processes selecting the content item for presentation to each user of the subset to a distribution of the probabilities of one or more selection processes selecting the content item for presentation to each user of the set;
generating weights for different ranges of probabilities of one or more selection processes selecting the content item for presentation based on the comparing;
generating a modified distribution of the probabilities of one or more selection processes selecting the content item for presentation to each user of the set by applying the weights to users of the set within corresponding ranges of probabilities, the modified distribution of the probabilities of one or more selection processes selecting the content item for presentation to each user of the set within a threshold amount of the distribution of probabilities of one or more selection processes selecting the content item for presentation to each user of the subset;
determining a rate of performing the specific action based on a number of occurrences of the specific action by users of the subset after being presented with the content item and a number of users of the subset;
determining an additional rate of performing the specific action based on a number of occurrences of the specific action by users of the set, the generated weights, and a number of users of the set; and
generating a metric based on a difference between the rate and the additional rate.

2. The method of claim 1, wherein generating weights for different ranges of probabilities of one or more selection processes selecting the content item for presentation based on the comparing comprises:
identifying a plurality of ranges of probabilities of one or more selection processes selecting the content item;
for each range of the plurality of ranges:
determining a percentage of users of the subset having determined probabilities within a range;
determining a percentage of users of the set having determined probabilities within the range; and
generating a weight for the range as a ratio of the percentage of users of the subset within the range to the percentage of users of the set having determined probabilities within the range.

3. The method of claim 1, wherein determining the additional rate of performing the specific action based on the number of occurrences of the specific action by users of the set, the generated weights, and the number of users of the set comprises:
for each range:
determining a number of occurrences of the specific action by users of the set having determined probabilities within a range;
applying a weight for the range to the number of occurrences of the specific action by users having determined probabilities within the range;
determining a sum of the weighted number of occurrences of the specific action by users within each range; and
determining the additional rate of performing the specific action as a ratio of the determined sum to the number of users of the set.

4. The method of claim 1, wherein determining the rate of performing the specific action based on a number of occurrences of the specific action by users of the subset after being presented with the content item and a number of users of the subset comprises:
determining the rate of performing the specific action as a ratio of the number of occurrences of the specific action by users of the subset to the number of users of the subset.

5. The method of claim 1, wherein the model is trained using characteristics of a percentage of users of the set and characteristics of a percentage of users of the subset.

6. The method of claim 1, wherein generating the modified distribution of the probabilities of one or more selection processes selecting the content item for presentation to each user of the set by applying the weights to users of the set within corresponding ranges of probabilities comprises:
applying a weight to a number of users of the set having determined probabilities within a range that increases the number of users of the set having determined probabilities within the range in response to the comparing indicating the number of users of the subset having determined probabilities within the range is greater than the number of users of the set having determined probabilities within the range.

7. The method of claim 1, wherein generating the modified distribution of the probabilities of one or more selection processes selecting the content item for presentation to each user of the set by applying the weights to users of the set within corresponding ranges of probabilities further comprises:
applying a weight to a number of users of the set having determined probabilities within a range that decreases the number of users of the set having determined probabilities within the range in response to the comparing indicating the number of users of the subset having determined probabilities within the range is less than the number of users of the set having determined probabilities within the range.

8. The method of claim 1, wherein identifying the set of users of the online system to whom the content item was not presented and having criteria satisfying at least a threshold amount of the targeting criteria included in the content item comprises:
identifying users of the online system having characteristics satisfying at least the threshold amount of the targeting criteria and to whom the content item was not presented in a specific time interval.

9. The method of claim 1, wherein determining an additional rate of performing the specific action based on the number of occurrences of the specific action by users of the set, the generated weights, and a number of users of the set comprises:
determining a number of occurrences of the specific action by users of the set after a time when the content item was presented to one or more users of the subset; and
determining the additional rate of performing the specific action based on the number of occurrences of the specific action by users of the set after the time when the content item was presented to one or more users of the subset, the generated weights, and a number of users of the set.

10. The method of claim 1, wherein the metric comprises the difference between the rate and the additional rate.

11. A computer program product comprising a computer readable storage medium having instructions encoded thereon that, when executed by a processor, cause the processor to:
receive a content item at an online system from a publishing user for presentation to users of the online system, the content item associated with a specific action and including targeting criteria identifying characteristics of users of the online system eligible to be presented with the content item;
identify opportunities to present content to users of the online system having characteristics satisfying at least a threshold amount of the targeting criteria included in the content item;
present the content item to a subset of the users of the online system having characteristics satisfying at least a threshold amount of the targeting criteria included in the content item;
identify a set of users of the online system to whom the content item was not presented and having criteria satisfying the targeting criteria included in the content item;
determine probabilities of one or more selection processes selecting the content item for presentation to various users of the subset to whom the content item was presented by applying a model to characteristics of each user of the subset;
determine probabilities of one or more selection processes selecting the content item for presentation to various users of the set to whom the content item was not presented by applying the model to characteristics of each user of the subset;
compare a distribution of the probabilities of one or more selection processes selecting the content item for presentation to each user of the subset to a distribution of the probabilities of one or more selection processes selecting the content item for presentation to each user of the set;
generate weights for different ranges of probabilities of one or more selection processes selecting the content item for presentation based on the comparing;
generate a modified distribution of the probabilities of one or more selection processes selecting the content item for presentation to each user of the set by applying the weights to users of the set within corresponding ranges of probabilities, the modified distribution of the probabilities of one or more selection processes selecting the content item for presentation to each user of the set within a threshold amount of the distribution of probabilities of one or more selection processes selecting the content item for presentation to each user of the subset;
determine a rate of performing the specific action based on a number of occurrences of the specific action by users of the subset after being presented with the content item and a number of users of the subset;
determine an additional rate of performing the specific action based on a number of occurrences of the specific action by users of the set, the generated weights, and a number of users of the set; and
generate a metric based on a difference between the rate and the additional rate.

12. The computer program product of claim 11, wherein generating weights for different ranges of probabilities of one or more selection processes selecting the content item for presentation based on the comparing comprises:
identify a plurality of ranges of probabilities of one or more selection processes selecting the content item;
for each range of the plurality of ranges:
determine a percentage of users of the subset having determined probabilities within a range;
determine a percentage of users of the set having determined probabilities within the range; and
generate a weight for the range as a ratio of the percentage of users of the subset within the range to the percentage of users of the set having determined probabilities within the range.

13. The computer program product of claim 11, wherein determine the additional rate of performing the specific action based on the number of occurrences of the specific action by users of the set, the generated weights, and the number of users of the set comprises:
for each range:
determine a number of occurrences of the specific action by users of the set having determined probabilities within a range;
apply a weight for the range to the number of occurrences of the specific action by users having determined probabilities within the range;
determine a sum of the weighted number of occurrences of the specific action by users within each range; and
determine the additional rate of performing the specific action as a ratio of the determined sum to the number of users of the set.

14. The computer program product of claim 11, wherein determine the rate of performing the specific action based on a number of occurrences of the specific action by users of the subset after being presented with the content item and a number of users of the subset comprises:
determine the rate of performing the specific action as a ratio of the number of occurrences of the specific action by users of the subset to the number of users of the subset.

15. The computer program product of claim 11, wherein the model is trained using characteristics of a percentage of users of the set and characteristics of a percentage of users of the subset.

16. The computer program product of claim 11, wherein generate the modified distribution of the probabilities of one or more selection processes selecting the content item for presentation to each user of the set by applying the weights to users of the set within corresponding ranges of probabilities comprises:
apply a weight to a number of users of the set having determined probabilities within a range that increases the number of users of the set having determined probabilities within the range in response to the comparing indicating the number of users of the subset having determined probabilities within the range is greater than the number of users of the set having determined probabilities within the range.

17. The computer program product of claim 11, wherein generate the modified distribution of the probabilities of one or more selection processes selecting the content item for presentation to each user of the set by applying the weights to users of the set within corresponding ranges of probabilities further comprises:
apply a weight to a number of users of the set having determined probabilities within a range that decreases the number of users of the set having determined probabilities within the range in response to the comparing indicating the number of users of the subset having determined probabilities within the range is less than the number of users of the set having determined probabilities within the range.

18. The computer program product of claim 11, wherein identify the set of users of the online system to whom the content item was not presented and having criteria satisfying at least the threshold amount of the targeting criteria included in the content item comprises:
identify users of the online system having characteristics satisfying at least the threshold amount of the targeting criteria and to whom the content item was not presented in a specific time interval.

19. The computer program product of claim 11, wherein determine the additional rate of performing the specific action based on the number of occurrences of the specific action by users of the set, the generated weights, and the number of users of the set comprises:
determine a number of occurrences of the specific action by users of the set after a time when the content item was presented to one or more users of the subset; and
determine the additional rate of performing the specific action based on the number of occurrences of the specific action by users of the set after the time when the content item was presented to one or more users of the subset, the generated weights, and the number of users of the set.

20. The computer program product of claim 11, wherein the metric comprises the difference between the rate and the additional rate.
